(19) United States
(12) Patent Application Publication
(10) Pub. No.: US 2004/0149944 A1
(43) Pub. Date: Aug. 5, 2004

(54) Electromechanical valve actuator

(76) Inventors: Mark L. Hopper, Ypsilanti, MI (US); John D. Norton, Ann Arbor, MI (US); Shawn H. Swales, Canton, MI (US); Vladimir V. Kokotovic, Bloomfield Hills, MI (US)

Correspondence Address: Douglas A. Mullen, Dickinson Wright PLLC, Suite 800, 1901 L Street N.W., Washington, DC, 20036, US

(21) Appl. No.: 10/760,742

(22) Filed: Jan. 20, 2004

Related U.S. Application Data
(60) Provisional application No. 60/443,100, filed on Jan. 28, 2003.

(51) Int. Cl. F16K 31/02

(52) U.S. Cl. 251/54; 251/129.16; 251/129.1

(57) ABSTRACT

An electromechanical valve including an energy absorption system to reduce or eliminate the force with which the armature contacts an electromagnet pole face. The energy absorption system absorbs kinetic energy from the armature assembly prior to the armature plate contacting the electromagnetic pole face to reduce the velocity or impact force of the armature plate against the electromagnet, thereby reducing noise, vibration, and harshness concerns associated with many electromechanical valve actuators. The cooperative nature of the energy absorption system allows damping even during short cycle times by the armature assembly.

### CROSS-REFERENCE TO RELATED APPLICATION

This application claims the benefit of U.S. Provisional Application No. 60/443,100, filed Jan. 28, 2003, the entire disclosure being considered part of the disclosure of this application and hereby incorporated by reference.

### BACKGROUND OF THE INVENTION

The present invention relates to electromechanical valve actuators and more particularly to electromechanical valve actuators that reduce or eliminate impact forces between an electromagnet and a movable armature.

Engine valves control the flow of gases in and out of the cylinders in internal combustion engines. As engine technology advances and manufacturers strive to increase engine power, improve fuel economy, decrease emissions, and provide more control over engines, manufacturers are developing electromechanical valve actuators to replace cam shafts for opening and closing engine valves. Electromechanical valve actuators allow selective opening and closing of the valves, thereby allowing greater control in response to various engine conditions.

Electromechanical valve actuators generally include an armature electromagnet and a valve electromagnet, each formed from a core having an embedded power coil. A spring loaded armature is movable between the electromagnets as the power coils are selectively energized to create a magnetic force for attracting the armature. The surface of the electromagnet to which the armature is attracted when the power coil of that electromagnet is energized is generally referred to as a pole face. The armature is coupled to the valve so that as the armature moves between the pole faces in pole-face-to-pole-face operation, the valve opens and closes.

One problem with electromechanical valve actuators is the forceful contact between the armature plate and the pole faces of the electromagnets. Forceful contact causes noise, vibration, and harshness issues, and decreases the durability of electromechanical valve actuators, thereby potentially causing operational failures. In operation, the armature plate is initially drawn to a pole face from a rest position between the electromagnets. During constant coil current conditions, as the armature plate approaches the electromagnet pole face, the gap between the armature and electromagnets decreases, resulting in an exponential increase of magnetic force acting on the armature. The exponential increase in magnetic attraction force between the armature and electromagnet causes the armature to increase in velocity as it approaches the electromagnet. This increase in velocity increases the contact force between a pole face and the armature plate. The impact of the armature plate on a pole face may also make quiet operation of electromechanical valve actuators difficult to achieve.

One of the present methods of reducing the impact and landing speed of the armature on the pole face includes controlling the shape, magnitude, and timing of the current profile sent to each power coil within the electromagnets. By controlling the current to the power coil, the magnetic force acting on the armature is controlled. When a soft landing is achieved, noise, vibration, and harshness issues are minimized, resulting in quiet and durable operation. However, unpredictable and time-varying disturbance forces, such as aerodynamic forces on the engine valve head, vibration, and other factors, create problems in achieving acceptably soft landing under all conditions by current control alone. Also, the cost of sensors and controllers to implement current control may be prohibitively expensive. Certain types of shaped power or current profiles supplied to the coil for softening the impact may increase the time the armature takes to travel from pole face to pole face. Any increase in travel time increases the transition time and may prevent the engine from operating properly because the attached valve cannot open and close fast enough.

To reduce the impact force between the electromagnets and armature plate to achieve soft landing of the armature against a pole face, some manufacturers have attempted to attach damping mechanisms to the armature stem. While these systems may provide a soft landing they create other problems such as increased travel time, increased mass on the movable armature, and increased assembly time. Another problem with these damping systems is ensuring that the damping system is capable of absorbing impact during the next cycle in all engine operating conditions and in a cost effective manner. Typically, the damping mechanisms use fluid pressure supplied by the engine oil system to reset the damping mechanism to a position capable of absorbing impact. One problem with using an engine oil system to provide the fluid pressure for reset is that the pressure may vary depending on engine rpm making it difficult to achieve soft landings in all engine operating conditions. For example, if the fluid supply is the engine oil system, the oil pressure supplied to the damping mechanisms when the engine is idling will be relatively low and, therefore, the recovery time of the damper to move from a compressed state to an extended state may be greater than the time the armature takes to move from the armature electromagnet to the valve electromagnet and back to the armature electromagnet. Slow recovery of the damper from the compressed to the extended state is especially noticeable when a cold engine is idling and it is desirable to open and close the valve quickly to limit the amount of cold air entering the engine. To provide a timely reset in all engine conditions, some dampers may require expensive additional fluid supply means such as a high pressure fluid pump.

Electromechanical valve actuators operate in high temperatures and must be capable of absorbing impacts within relatively short cycle times. Under normal engine operating conditions the armature typically cycles between electromagnetic pole faces about 250 to 3500 times per minute. It is difficult to provide lubrication to the armature stems to reduce friction because oil channels may interfere with magnetic flux carrying components, thereby reducing the potential magnetic force applied by an electromagnet at a specified current level. It is also difficult to cool the electromechanical valve actuators due to the difficulty in providing cooling fluid where needed. Therefore, most electromechanical valve actuators are not able to provide a damping mechanism with a system that communicates a cooling and lubricating fluid to the electromechanical valve actuator.

### SUMMARY OF THE INVENTION

The aforementioned problems are overcome in the present invention wherein an electromechanical valve includes an energy absorption system to reduce or eliminate the force with which the armature contacts an electromagnet pole face. The energy absorption system may also act as a lubrication system to reduce friction between the armature stem and the liner as well as cool the electromechanical valve actuator. More specifically, the energy absorption system absorbs kinetic energy from the armature assembly prior to the armature plate contacting the electromagnetic pole face to reduce the velocity or impact force of the armature plate against the electromagnet, thereby reducing noise, vibration, and harshness concerns associated with many electromechanical valve actuators.

The energy absorption system generally includes a first damper operatively connected to a second damper wherein as one of the first and second dampers is compressed, the other of the first and second dampers is extended. The dampers are situated at least partially in the electromagnets. More specifically, the compression of one of the dampers assists in the extension of the other of the dampers. The cooperate nature of the dampers allows quick recovery times by using fluid displaced during compression of one damper to assist in the extension of the other damper. The dampers are typically arranged in an opposing relationship and connected with a fluid line.

The method of damping impact forces in electromechanical valve actuators includes the steps of compressing a first damper from the extended position to the compressed position to displace a fluid, and extending a second damper from the compressed position to the extended position using the fluid displaced from the compression of the first damper. The method of damping further includes the step of providing the fluid to the first and second dampers, which may act as a cooling and lubricating fluid by configuring the first and second dampers to have a positive leak rate.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention will become more fully understood from the detailed description given below, the appended claims, and the accompanying drawings in which:

FIG. 1 is a sectional view of the linear electromechanical valve actuator showing the energy absorption system;

FIG. 2 is a sectional view of a lever electromechanical valve actuator showing the energy absorption system;

FIG. 3 is a schematic view of the electromechanical valve actuator;

FIG. 4 is an alternative schematic view of the electromechanical valve actuator; and

FIG. 5 is a graphical view of the position of the bumper over time, showing the landing profile of the armature plate.

### DETAILED DESCRIPTION OF THE PREFERRED EMBODIMENT

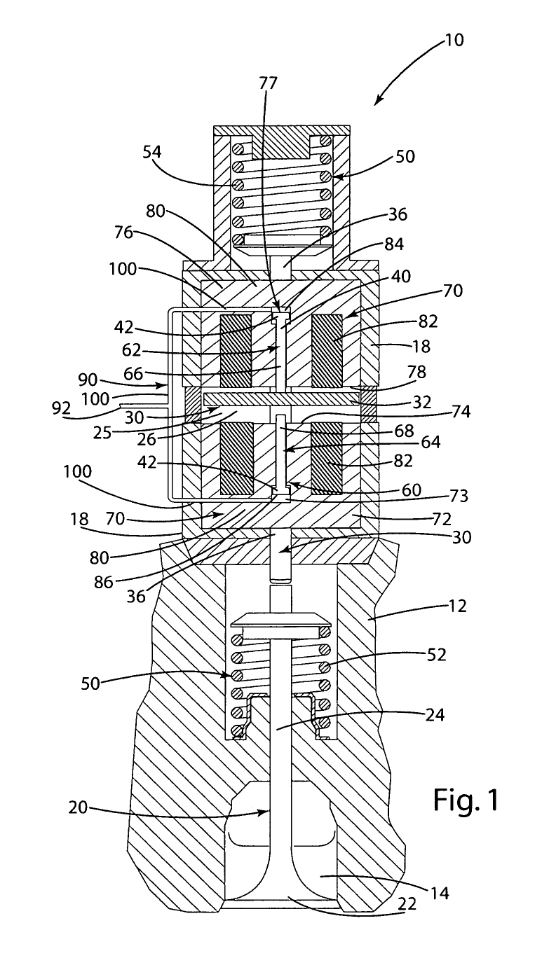

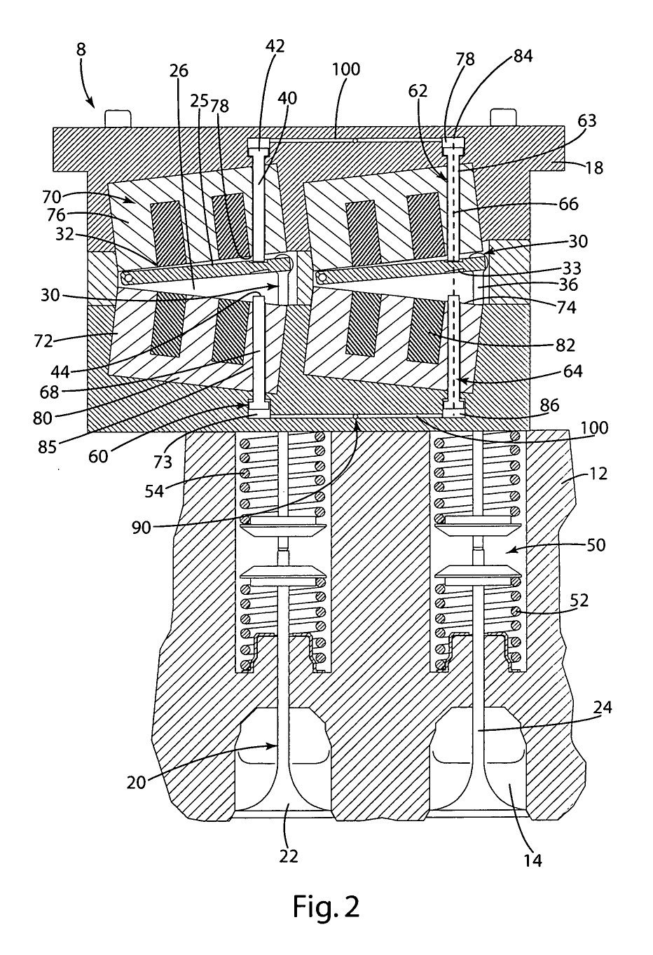

A linear electromechanical valve actuator 10, typically mounted on an internal combustion engine 12 to open and close the valves 20 (e.g. the intake or exhaust valves), is illustrated in FIG. 1 and incorporates an energy absorption system 60. A lever electromechanical valve actuator 8 incorporating the energy absorption system 60 is illustrated in FIG. 2 and generally includes the same structure as the linear electromechanical valve actuator shown in FIG. 1, except that the lever electromechanical valve actuator is configured so that the armature assembly 30 pivots about an axis instead of moving along an axis. The electromechanical valve actuators 8, 10 generally include an outer housing 18, an electromagnet assembly 70 having a valve electromagnet 72 and an armature electromagnet 76, and an armature assembly 30 situated between the electromagnets 72, 76. The electromechanical valve actuators 8 and 10 drive an engine valve 20 having a valve head 22 and a valve stem 24. The valve head 22 closes a valve port 14 on the engine 12 to selectively allow the flow of gases in and out of a cylinder (not shown) on the engine 12. The electromechanical valve actuators 8, 10 include an energy absorption system 60 which reduces noise, vibration, and harshness issues by reducing or eliminating the force of impact of the armature assembly 30 against the electromagnets 72, 76 during operation. More specifically, the energy absorption system 60 extracts kinetic energy from the armature plate 32, thereby slowing the armature as it approaches the pole face 74, 78 of the electromagnet 72, 76.

The armature assembly 30 includes an armature plate 32 and an armature stem 36 as illustrated in FIGS. 1 and 2. For the linear electromechanical valve actuator 10, the armature stem 36 passes through the armature electromagnet 76 and valve electromagnet 72 as illustrated in FIG. 1 and in the lever electromechanical valve actuator 8, the armature stem 36 passes through the valve electromagnet 72, as illustrated in FIG. 2. The armature plate 32 is generally formed from laminated plates (not shown) to improve the magnetic efficiency of the electromechanical valve actuator.

The electromagnet assembly 70 includes the valve electromagnet 72 having a valve pole face 74 and the armature electromagnet 76 having the armature pole face 78. Each of the electromagnets 72, 76 includes a core 80 and a power coil 82 situated in the core. The power coils 82 are connected to a source of electric current (not shown) and are selectively energized by a controller (not shown) such as an engine management system. As the power coils 82 are selectively energized, the created magnetic field attracts the armature plate 32 to the energized electromagnet 72, 76 and moves the armature plate 32 between pole faces 74, 78 to drive the attached engine valve 20. Once in motion, a spring assembly 50, such as the illustrated armature spring 54 and valve spring 52, provides the force to move the armature plate 32 from pole face to pole face with the electromagnets 72, 76 controlling the movement of the armature plate as well as securing the armature plate to one of the pole faces to hold the valve 20 in an open or closed position.

The electromagnets 72, 76 further define a first cavity 77 associated with the armature electromagnet 76 and a second cavity 73 associated with the valve electromagnet 72. The cavities 73, 77 may vary in size and shape and generally include a chamber and a passage in communication between the respective chamber and pole face 74, 78. More specifically, the first cavity 77 includes a first chamber 84 and the second cavity 73 includes a second chamber 86. A passage 85 communicates between the first chamber 84 and armature pole face 78 as well a between the second chamber 86 and the valve pole face 74. It should be readily recognized to one skilled in the art that the cavities 73, 77 may be completely located in the electromagnets 72, 76 (FIG. 1), partially located in the electromagnets and the housing (FIG. 2), or partially located in the electromagnets, the housing and an intermediate member secured between the housing and electromagnets (not shown). The electromagnets 72, 76 are generally formed from a series of laminated plates. The cavities 73, 77 may be formed by a progressive die during formation of the plates, which are then joined by a molding compound. A liner (not shown) may be added to the cavities to reduce sliding friction along the cavity walls.

The structure of the energy absorption system 60 will now be described in greater detail with reference to the linear electromagnetic valve actuator 10 shown in FIG. 1. The energy absorption system 60 includes a first damper 62 associated with the armature electromagnet 76 and a second damper 64 associated with the valve electromagnet 72. The first and second dampers 62, 64 are in an opposed relationship so as to dampen the movement of the armature plate 32 prior to the armature plate contacting the respective electromagnets 72, 76, as described below.

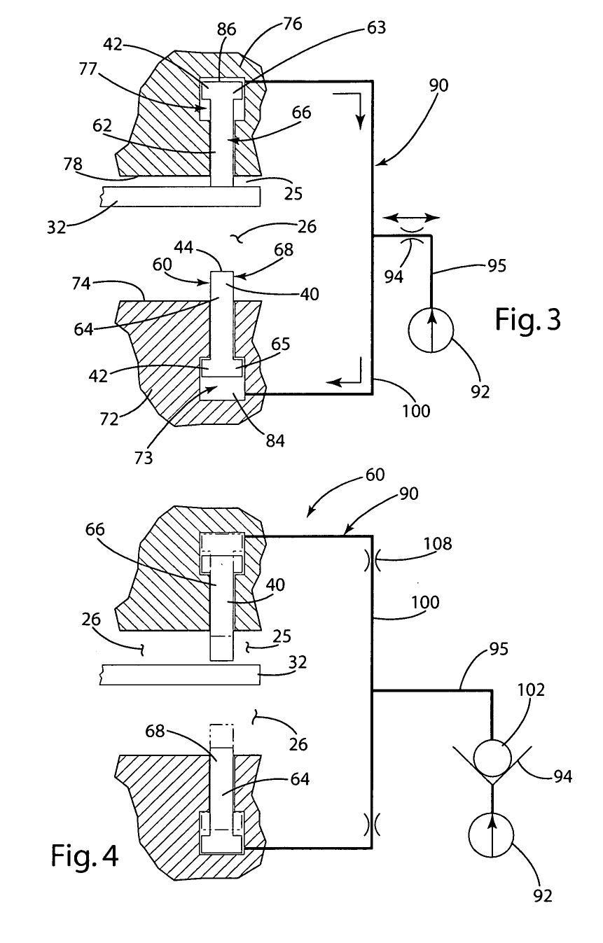

The first damper 62 includes the first fluid chamber 84 and a first bumper 66. The second damper 64 includes the second fluid chamber 86 and a second bumper 68. Each of the bumpers 66, 68 include a piston 42 operatively disposed in the respective fluid chamber 84, 86 and a shaft 40 disposed in the passage 85 extending from the piston 42 toward the respective pole face 74, 78. The piston 42 is sized to provide a substantially fluid tight engagement with the side walls 88 of the respective fluid chamber 84, 86. Each bumper 66 and 68 is movable within cavity 73 and 77, specifically within the fluid chambers 84 and 86 and the passage 85 between a compressed position, as shown by the first bumper 66 in FIG. 3 and an extended position, as shown by the second bumper 68 in FIG. 3. FIG. 4 also illustrates the movement of the bumpers 66, 68 with phantom lines. In the illustrated embodiment, the bumper ends 44 stand slightly proud relative to the respective pole face 74, 78 specifically about 0.3 mm in the compressed position. In some embodiments it may be desirable for the bumper end to be substantially flush with the respective pole face to reduce the amount of current necessary to hold the armature plate 32 in close proximity to the respective electromagnet 72, 76 by minimizing the air gap 25 between the armature plate and respective electromagnet. In the extended position, the bumpers 66, 68 extend into the gap 26 between the electromagnets for contacting engagement with the armature plate 32 before the armature plate contacts one of the electromagnets 72, 76.

The bumpers 66 and 68 are formed from a material that resists oil swelling and maintains performance in high temperatures, up to 200° C. In the illustrated embodiment, the bumpers 66 and 68 are formed at least in part from a polymide such as DuPont Vespel® to allow each bumper to compress thereby providing cushioning, in addition to cushioning provided through the fluid chamber, when the armature plate 32 contacts the bumper. Other materials particularly suited for the bumpers 66, 68 include steel and aluminum. The piston 42 may also be formed from a different material than the shaft 40, as illustrated in FIG. 3, to allow better durability and energy absorption characteristics. For example, the piston 42 may be formed from steel while the shaft 40 is formed from DuPont Vespel®.

The energy absorption system 60 also includes a fluid system 90 operatively connecting the first fluid chamber 84 to the second fluid chamber 86 of the opposed dampers 62 and 64. The fluid system 90 is illustrated to include a fluid line 100 (FIGS. 1 and 3) that hydraulically intercouples the fluid chambers 84, 86. A supply header 92 is coupled to the fluid line 100 to provide positive fluid flow to the fluid lines 100 and thereby to the fluid chambers 84, 86. The supply header 92 may be the engine oil system or some other system that is capable of supplying a fluid to the fluid system 90. The fluid line 100 may be formed in part or in whole by the electromagnets 72, 76 and housing 18, as illustrated in FIGS. 1 and 2.

The fluid system 90 may further include a supply restriction 94, as illustrated in FIG. 3 to reduce the amount of fluid flowing from the fluid line 100 into the supply header 92 during compression of one of the dampers 62, 64. This supply restriction 94 may also be formed as a check ball 102 to prevent outflow of the fluid from the fluid lines 100 during compression of one of the dampers 62, 64. Due to the relatively quick compression of the dampers 62, 64 by the armature plate 32, without the supply restriction 94, the fluid may flow into the supply header 92 along the path of least resistance instead of flowing to the opposing damper 62, 64 to extend that damper while the other damper is being compressed. The supply restriction 94 may also be formed by the diameter of the supply line 95.

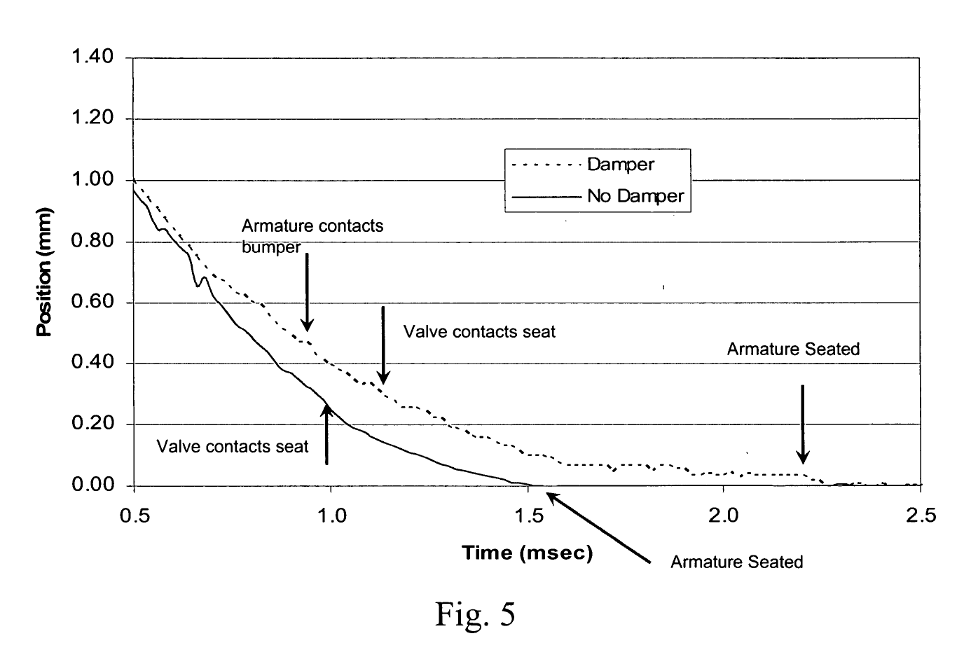

The fluid system 90 may further include line restrictions 108 as illustrated in FIG. 4. The line restrictions 108 are generally formed by the minimum size of the fluid line 100 extending between the fluid chambers 84, 86 and the supply line 95. The line restrictions 108 are sized to ensure the proper rate of compression of each bumper 66, 68. For example, if the line restrictions 108 are too large, the bumpers 66, 68 may compress too quickly and not remove enough kinetic energy from the armature plate 32 so that the armature plate impacts one of the pole faces. If the line restrictions are too small, the bumpers 66, 68 may compress too slowly potentially preventing the valve from opening or closing in the desired amount of time, as well as potentially causing difficulties in retaining the armature plate 32 against the respective electromagnet. The size of the line restrictions 108 is determined by the amount of kinetic energy to be extracted from the armature plate, or the desired compression time. In the illustrated embodiment, the line restrictions 108 are sized so that the dampers compress in less than 0.5 msec as shown in FIG. 5.

The operation of the energy absorption system 60 will now be described in greater detail with reference to FIGS. 3-4. In FIG. 3, the controller has energized the power coil 82 of the armature electromagnet 76 to draw the armature plate 32 to the armature electromagnet to close the valve 20. As the armature plate 32 approaches the armature electromagnet 76, it contacts the bumper end 46 before contacting the armature pole face 78. After contacting the bumper end 44, the first bumper 66 is moved from its extended position, shown in FIG. 4, to its compressed position, shown in phantom lines in FIG. 4. As the first bumper 66 moves from the extended position to the compressed position, the piston 42 displaces fluid from the first fluid chamber 84, through the fluid lines 100 and into the second fluid chamber 86 to assist in moving the second bumper 68 from its compressed position, shown in FIG. 4, to its extended position, shown in phantom lines in FIG. 4. More specifically, increased fluid pressure in the fluid lines 100 and fluid chambers 84, 86 causes the second bumper 68 to move from the compressed position to the extended position. In a similar fashion, as the armature plate 32 is moved to contact the second damper under the force of the spring assembly 50 and valve electromagnet 72, the armature plate contacts the bumper end 44 of the second bumper 68 and displaces the second bumper from the extended position to the compressed position. During movement of the second damper, the piston 42 displaces fluid from the second fluid chamber 86 through the fluid line 100 and into the first fluid chamber 84 to exert a pressure against the piston of the first bumper 66 to extend the first bumper from its compressed position to its extended position. Of course, the supply header 92 may be supplying a constant fluid supply and therefore start the damper moving from the compressed position to the extended position before the fluid displaced during the compression of the opposing damper assists in the extension. The supply restriction 94 also ensures that the fluid expelled from one fluid chamber is directed at least partially into the other fluid chamber and not into the potentially lower pressure supply header.

With the above in mind, the energy absorption system 60 of the present invention reduces noise, vibration, and harshness issues while providing quick recovery times. More specifically, the cooperative nature of the dampers 62, 64 allows the compression of one damper to assist in the extension of the other damper and allow the energy absorption system to recover before absorbing the next impact of the armature plate 32 against the dampers. The energy absorption system uses the kinetic energy removed from the armature plate 32 in resetting the dampers to an extended state, thereby providing an efficient energy absorption system with minimal parts and low cost. Therefore, the energy absorption system 60 may operate properly with low pressure supply headers, allowing use of the engine oil system as a supply header to reduce assembly, manufacturing, and component costs. More specifically, the cooperative nature of the dampers 62, 64 allows a low pressure supply header having a fluid pressure less than 10 psi to provide sufficient recovery in less than 5.6 msec.

While the cavities 73, 77 are illustrated in FIG. 1 as being entirely formed by the electromagnet, the cavities may be partially formed from the housing or other structural component of the valve actuators, as illustrated in FIG. 2. For example, as shown in FIG. 2, the cavities 73, 77 and fluid line 100 are formed primarily in the housing with only the passage 85 extending through the electromagnets 72, 76. The fluid filled chambers 84, 86 may also be lined to allow smooth durable movement of the dampers 62, 64, specifically the pistons 42 within the chambers.

While the above embodiments have been described as one pair of opposing dampers, it may be preferable to use more than one pair of opposing dampers. For example, with regards to the linear actuator 10, it may be desirable to place a pair of opposing dampers on each side of the armature stem 36 for balanced operation. More specifically, in the linear electromechanical valve actuator 10, the dampers 62, 64 are situated on both sides of the armature stem 36, approximately aligned with the armature stem, thereby providing each electromechanical valve actuator with a total of four dampers.

In the lever electromechanical valve actuator 8 illustrated in FIG. 2, the dampers 62, 64 are generally located near one side of the electromagnets 72, 76 and set back slightly within the envelope of the electromagnets 72, 76 to provide maximum damping. Indents 33 may be provided on the armature plate 32 to ensure that the bumper end 44 contacts the armature plate approximately perpendicular to the axis 63 of the bumpers 66, 68 to ensure durability and prevent binding of the bumpers with the passage 85 or walls 88 of the fluid chambers 84, 86. The location of the dampers 62, 64 on the electromagnets 72, 76 may vary as needed.

The substantially fluid tight engagement between the fluid chamber side walls 88 and piston 42 may allow a positive leak rate to provide lubrication and cooling of the armature. The leakage rate for each damper 62, 64 is 0.077 to 0.17 mL/sec at low pressure (15 psi) and during long cycle times such as at engine idle and 0.43 to 0.96 mL/sec (85 psi) during quick cycle times and high pressure. This leakage rate allows a small flow of fluid so that the fluid in the fluid lines 100 does not become overheated. The leakage of the fluid also provides a constant supply of lubricating fluid to the electromechanical valve actuator.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

1. An electromechanical valve actuator comprising:
a first damper operatively connected to a second damper, said first and second dampers each having a compressed state and an extended state, wherein as one of said first and second dampers is moved from said extended state to said compressed state, the other of said first and second dampers is moved to said extended state and wherein the movement of said one of said first and second dampers to said compressed state assists in movement of said other of said first and second dampers to said extended state.

2. The electromechanical valve actuator of claim 1 wherein said first damper opposes said second damper.

3. The electromechanical valve actuator of claim 1 further including a fluid line connecting said first and second dampers and wherein a fluid is displaced within said fluid line as one of said first and second dampers is moved to said compressed state and the other of said first and second dampers is moved to said extended state.

4. The electromechanical valve actuator of claim 3 wherein said fluid line includes a line restriction between said first and second dampers for restricting the movement of said fluid between said first and second dampers.

5. The electromechanical valve actuator of claim 3 further including a supply header connected to said fluid line for supplying fluid to said fluid line and to said first and second dampers, and a supply restriction between said fluid line and said supply header for restricting the flow of said fluid from said fluid line to said supply header as one of said first and second dampers is moved to said compressed state.

6. The electromechanical valve actuator of claim 3 wherein said first damper includes a first fluid chamber and a first bumper and wherein said second damper includes a second fluid chamber and a second bumper and wherein as said first damper is moved from said compressed state, said first bumper is moved to displace fluid from said first fluid chamber to exert a fluid pressure through said fluid line on said second bumper, said second bumper moving to an extended position in response to said fluid pressure.

7. The electromechanical valve actuator of claim 1 wherein said first and second dampers each include a fluid chamber and a bumper operatively coupled to said fluid chamber and wherein the volume of fluid in each of said fluid chambers changes in response to the position of the first and second bumpers.

8. The electromechanical valve actuator of claim 7 wherein said fluid chamber includes a leak rate of less than 1 ml per second.

9. An electromechanical valve actuator comprising:
a valve electromagnet having a valve pole face, said valve electromagnet defining a valve cavity;
an armature electromagnet having an armature pole face, said armature electromagnet defining an armature cavity, said armature pole face being spaced from said valve pole face to define a gap therebetween;
a plate movable in said gap between said valve and armature pole faces;
a first damper in fluid communication with a second damper, said first damper including a first bumper and a first fluid chamber disposed within said armature cavity, said second damper including a second bumper and a second fluid chamber disposed within said valve cavity; and
a fluid line operatively connecting said first fluid chamber and said second fluid chamber, and wherein as said plate moves said first bumper to a compressed position, said first bumper forces fluid from said first chamber through said fluid line to exert a fluid pressure on said second bumper, said second bumper moving to an extended position in response to said fluid pressure.

10. The electromechanical valve actuator of claim 9 further including a supply header for providing fluid to said fluid line and a supply restriction between said supply header and said fluid line, said supply restriction limiting the flow of fluid from said fluid line into said supply header as one of said first and second damper is moved to the compressed position.

11. The electromechanical valve actuator of claim 10 wherein said supply restriction is a check ball and a check ball seat.

12. The electromechanical valve actuator of claim 11 wherein said bumper is formed from Vespel.

13. A method of damping impact forces in electromechanical valve actuators having an armature plate arranged between a pair of electromagnets, and a first damper included in one of said electromagnets and a second damper included in the second of said electromagnets and opposing said first damper, said dampers having an extended and compressed state, said dampers being operatively connected with a fluid line, said method including the steps of:
compressing said first damper from the extended state to the compressed state to displace a fluid;
extending said second damper from the compressed state to the extended state using the fluid displaced from the compression of the first damper.

14. The method of claim 13 furthering including the step of providing fluid to the first and second dampers.

15. The method of claim 14 further including the step of providing a cooling and lubricating fluid to said first and second dampers, and wherein said first and second dampers have a leak rate up to 1 ml/sec.

16. The method of claim 13 wherein said first and second dampers move from the extended stated to the compressed state in less than 0.5 msec.

17. The method of claim 18 wherein said valve includes and open and a closed position and wherein said method further includes the step of providing sufficient current level to the electromagnets to prevent the extension of said first or second damper while said armature plate engages said first or second damper.

18. The method of claim 13 further including the step of limiting the flow of fluid from the fluid line to the supply header as one of said dampers is moved to the compressed position.
